(19) United States
(12) Patent Application Publication
(10) Pub. No.: US 2024/0276522 A1
(43) Pub. Date: Aug. 15, 2024

(54) SIDELINK TRANSMISSION TECHNIQUE

(71) Applicant: Telefonaktiebolaget LM Ericsson (publ), Stockholm (SE)

(72) Inventors: Jose Angel LEON CALVO, AACHEN (DE); Shehzad Ali ASHRAF, MUNICH (DE); Ricardo BLASCO SERRANO, ESPOO (FI); Jeong Hun KIM, KANATA (CA)

(73) Assignee: Telefonaktiebolaget LM Ericsson (publ), Stockholm (SE)

(21) Appl. No.: 18/561,678

(22) PCT Filed: May 19, 2022
(86) PCT No.: PCT/EP2022/063569

§ 371 Date: Nov. 16, 2023

Related U.S. Application Data
(60) Provisional application No. 63/190,720, filed on May 19, 2021.

(51) Int. Cl. H04W 72/25; H04W 72/566

(52) U.S. Cl. CPC H04W 72/25; H04W 72/569

(57) ABSTRACT

A technique for performing a transmission on a sidelink, SL, from a transmitting radio device to one or more receiving radio devices is described. As to a method aspect of the technique, a channel of the SL is sensed during a sensing window (420) upon arrival of data for the transmission on the SL, sensing. A duration (422) of the sensing window (420) depends on a transmission requirement (440) associated with the data. Based on a result of the sensing of the channel during the sensing window (420), resources of the channel are selected in a resource selection window (430) for the transmission of the data.

### TECHNICAL FIELD

The present disclosure relates to a technique for sidelink transmission. More specifically, and without limitation, a method and a device are provided for performing a transmission on a sidelink from a transmitting radio device to one or more receiving radio devices.

### BACKGROUND

The Third Generation Partnership Project (3GPP) specified proximity services (ProSe) for radio access technologies (RATs) such as Long Term Evolution (LTE) in Releases 12 and 13, targeting public safety use cases (e.g., first responders) as well as a small subset of commercial use cases (e.g., discovery). The ProSe comprise device-to-device (D2D) communications using a sidelink (SL) interface between radio devices, which are denoted user equipments (UEs) in 3GPP RATs.

For LTE Releases 14 and 15, 3GPP introduced major changes to the SL framework with the aim of supporting vehicular communications, which are also referred to as V2X communications, wherein V2X (as an abbreviation for vehicle-to-everything or vehicle-to-anything) collectively refers to communications between vehicle and any other endpoint (e.g., a vehicle, a pedestrian, etc.). Releases 14 and 15 enabled basic V2X use cases such as day-1 safety.

For Release 16, 3GPP specified the SL interface for the Fifth Generation (5G) New Radio (NR). The SL in NR Release 16 enables advanced V2X services, which can be categorized into four use case groups: vehicles platooning, extended sensors, advanced driving and remote driving. The advanced V2X services require a SL that meets stringent requirements in terms of latency and reliability. The SL of NR is designed to provide higher system capacity and better coverage, and to allow for an easy extension to support future development of further advanced V2X services and other related services.

Given the targeted V2X services using the SL of NR, it is commonly recognized that groupcast or multicast as well as unicast transmissions are desired, in which the intended one or more receivers of a message are only a subset of the UEs (e.g., vehicles) in proximity to the transmitter, i.e. a groupcast, or is a single UE (e.g., vehicle), i.e. a unicast. For example, in the platooning service there are certain messages that are only of interest to the members of the platoon, making the members of the platoon a natural groupcast. In another example, the see-through use case largely involves a pair of vehicles, for which unicast transmissions naturally fit. Therefore, the SL of NR not only supports broadcast, as the SL of LTE does, but also groupcast and unicast transmissions.

Like the SL of LTE, the SL of NR is designed in such a way that operation of the SL is possible with and without radio access network (RAN) coverage and with varying degrees of interaction between the UEs and the RAN, including support for standalone and network-less operation.

For Release 17, 3GPP is working on multiple enhancements for the SL with the aim of extending the support for V2X and to cover other use cases such as public safety (e.g., as described in the 3GPP document RP-193231). Among these, improving the performance of power limited UEs (e.g., pedestrian UEs, first responder UEs, etc.) and improving the performance using resource coordination are considered critical.

Sensing-based resource selection is one of the means for improving performance by resource coordination. In existing sensing operations, a sensing window has a fixed size. However, transmission requirements of the packet to be transmitted vary depending on the latency requirements. Given the fixed size of the sensing window, it may not be possible to perform the packet transmission in fulfilment of the transmission requirements. For example, a small packet delay budget may lead to a situation that the resource selection window subsequent to the sensing window is not sufficiently large for the given packet so that a later delay transmission violates the transmission requirements.

### SUMMARY

Accordingly, there is a need for a more flexible sidelink transmission technique. An alternative or more specific object is to fulfil different transmission requirements of traffic to be transmitted on the sidelink.

As to a method aspect, a method of performing a transmission on a sidelink (SL) from a transmitting radio device to one or more receiving radio devices is provided. The method comprises or initiates a step of sensing, upon arrival of data for the transmission on the SL, a channel of the SL during a sensing window. A duration of the sensing window depends on a transmission requirement associated with the data. The method further comprises or initiates a step of selecting, based on a result of the sensing of the channel during the sensing window, resources of the channel in a resource selection window for the transmission of the data.

The method aspect may be implemented alone or in combination with any one of the embodiments disclosed herein.

By changing the duration of the sensing window for the sensing-based resource selection depending on the transmission requirement, data (e.g., data packets or data traffic) associated with a more stringent transmission requirement may be transmitted in the selected resources after the sensing window (e.g., in fulfilment of a latency requirement as an example of the transmission requirement) that may be shorter compared to the (e.g., full) sensing window used before transmitting data associated with a less stringent transmission requirement.

The resources of the channel may be selected in a resource selection window in fulfilment of the transmission requirement.

The transmission requirement associated with the data may be a packet delay budget (PDB).

Alternatively or in addition, a method of performing a transmission on a SL from a transmitting radio device to one or more receiving radio devices is provided. The method comprises or initiates a step of sensing, upon arrival of data for the transmission on the SL, a channel of the SL during a sensing window. A duration of the sensing window depends on a parameter (e.g., a transmission requirement) associated with the data and/or the transmission of the data. Examples for the parameter may include a packet delay budget (e.g., associated with the data, the transmitting radio device, and/or the transmission of the data) and/or a priority (e.g., associated with the data, the transmitting radio device, and/or the transmission of the data). The method further comprises or initiates a step of selecting, based on a result of the sensing of the channel during the sensing window, resources of the channel in a resource selection window prior to expiry of the PDB for the transmission of the data.

Alternatively or in addition, a method of performing a transmission on a SL from a transmitting radio device to one or more receiving radio devices is provided. The method comprises or initiates a step of sensing, upon arrival of data for the transmission on the SL, a channel of the SL during a sensing window, wherein a duration of the sensing window depends on a packet delay budget (PDB) associated with the data. The method further comprises or initiates a step of selecting, based on a result of the sensing of the channel during the sensing window, resources of the channel in a resource selection window prior to expiry of the PDB for the transmission of the data.

The channel may be a radio channel or an optical channel. Alternatively or in addition, the channel may be a broadcast channel.

The sensing window and the resource selection window may be disjoint, i.e., non-overlapping.

The resource selection window may end upon or prior to expiry of the PDB.

The sensing of the channel may comprise receiving a transmission from one or more radio devices other than the transmitting radio device and/or from the one or more receiving radio devices. The transmission received from the one or more other radio devices in the sensing window may be indicative of a further transmission of the respective one or more other radio devices. For example, the transmission received from the one or more other radio devices may comprise a booking message. The booking message may be indicative of a further radio resource (e.g., planned or scheduled or booked) for the further transmission of the respective one or more other radio devices, e.g., within the resource selection window.

The result of the sensing of the channel may be indicative of one or more slots (e.g., in the resource selection window) that are at least one of idle, usable, and available for the transmission.

The transmission requirement may comprise, or is indicative of, at least one of: a packet delay budget (PDB) associated with the data and a priority associated with the data.

The duration of the sensing window may depend on at least one of the PDB and the priority.

The resources of the channel may be selected in the resource selection window prior to expiry of the PDB for the transmission of the data.

The resource selection window may end prior to the expiry of the PDB. Alternatively or in addition, the selected resource may occur prior to the expiry of the PDB.

The duration of the sensing window may be reduced relative to a full duration of a full sensing window. The reduction of the duration of the sensing window relative to the full duration of the full sensing window may depend on the PDB and/or the priority.

The resource selection window may start prior to the end of the full sensing window depending on the transmission requirement.

The resource selection window may overlap with the full sensing window.

The duration of the sensing window may be reduced relative to a full duration of a full sensing window if the transmission requirement is indicative of a first priority. Optionally, the channel may be sensed during the full duration if the transmission requirement is indicative of a second priority that is lower than the first priority.

The duration of the sensing window may depend on a time period remaining until the expiry of the PDB.

Alternatively or in addition, the transmitting radio device may determine the duration of the sensing window to be equal to or greater than a minimum duration that depends on the transmission requirement.

The minimum duration may be reduced if the transmission requirement is indicative of a first priority as compared to a minimum duration if the transmission requirement is indicative of a second priority that is lower than the first priority.

Alternatively or in addition, the transmitting radio device may determine the duration of the sensing window to be equal to or greater than a minimum duration that depends on the PDB. Optionally, the minimum duration of the sensing window may depend on a time period remaining until the expiry of the PDB.

Alternatively or in addition, the transmitting radio device may determine the duration of the sensing window to be equal to or less than a maximum duration that depends on the transmission requirement. Optionally, the maximum duration may be reduced if the transmission requirement is indicative of a first priority as compared to a maximum duration if the transmission requirement is indicative of a second priority that is lower than the first priority.

Alternatively or in addition, the transmitting radio device may determine the duration of the sensing window to be equal to or less than a maximum duration that depends on the PDB. Optionally, the maximum duration of the sensing window may depend on a time period remaining until the expiry of the PDB.

Alternatively or in addition, a duration of the resource selection window may depend on the transmission requirement.

A duration of the resource selection window may be reduced relative to a full duration of a full resource selection window. Optionally, the reduction may depend on the PDB and/or the priority.

Alternatively or in addition, a duration of the resource selection window may depend on the PDB. Optionally, the duration may depend on a time period remaining until the expiry of the PDB.

The transmitting radio device may determine the duration of the resource selection window to be equal to or greater than a minimum duration that depends on the PDB. Optionally, the minimum duration may depend on a time period remaining until the expiry of the PDB. Alternatively or in addition, the transmitting radio device may determine the duration of the resource selection window to be equal to or less than a maximum duration that depends on the PDB. Optionally, the maximum duration may depend on a time period remaining until the expiry of the PDB.

The duration of the resource selection window and/or a minimum duration of the duration of the resource selection window may include a time period for a re-transmission of the data to the one or more receiving radio devices. Alternatively or in addition, the duration of the resource selection window and/or the minimum duration of the duration of the resource selection window may include a time period for at least one of receiving a negative acknowledgment (NACK) from the one or more receiving radio devices and the re-transmission of the data to the one or more receiving radio devices.

The sum of the duration of the sensing window and a duration of the resource selection window may be equal to or less than a time period remaining until expiry of the PDB.

Alternatively or in addition, the duration of the sensing window may be equal to or less than a time period remaining until expiry of the PDB minus a duration for at least one of the selecting of the resources in the resource selection window and the transmission of the data in the selected resource.

The duration of the sensing window may correspond to a time period remaining until expiry of the PDB minus a duration for at least one of: the selecting of the resources in the resource selection window, the transmission of the data in the selected resource, receiving a NACK for the transmitted data, and a (e.g., potential) re-transmission of the data (e.g., responsive to the received NACK).

Alternatively or in addition, the method may further comprise or initiate a step of arriving of the data for the transmission and/or a step of transmitting the data in the selected resource.

The data may arrive (e.g., may be received) at a layer of a protocol stack for the communication or transmission on the channel, e.g., from a layer that is higher than the layer for the communication or transmission on the channel.

The method may be performed by the transmitting radio device.

The method may further comprise or initiate a step of receiving a control message at the transmitting radio device. The control message may be indicative of the transmission requirement.

The control message may be received from a network node of a radio access network (RAN) serving the transmitting radio device. Alternatively or in addition, the control message may be received from one or more of the receiving radio devices.

The transmission requirement (e.g., a QoS) associated with the data may be exchanged as part of a discovery procedure of the SL. For example, the control message may allow the transmitting radio device to discover the one or more receiving radio devices that can provide a desired QoS when receiving or relaying the data. Alternatively or in addition, the desired QoS may be exchanged (i.e., by means of the control message) during connection establishment.

A control message transmitted from the transmitting radio device to the one or more receiving radio devices may be indicative of the transmission requirement (e.g., a QoS of the data), optionally used according to a QCI. Alternatively or in addition, the control message transmitted from the one or more receiving radio devices to the transmitting radio device may be indicative of the transmission requirement (e.g., a QoS of the data), optionally that overrules the QCI of the EPS bearer, e.g., by requesting a further EPS bearer.

The duration of the sensing window may be determined depending on the transmission requirement so that at least a minimum duration of the resource selection window required to perform the resource selection is achieved.

Alternatively or in addition, the transmission requirement may comprise, or may be indicative of, a re-evaluation operation or a pre-emption operation.

Alternatively or in addition, the transmission requirement may comprise, or may be indicative of, at least one of: a priority of the data, a latency requirement of the data, a PDB of the data, a time remaining until expiry of the PDB, a duration of the resource selection window, and a minimum of the duration of the resource selection window required by the transmitting radio device for performing the selecting step. Optionally, the minimum of the duration of the resource selection window required by the transmitting radio device for performing the selecting step may depend on the priority of the data.

Alternatively or in addition, the transmission requirement may comprise, or may be indicative of, parameters related to at least one of: the data, the transmission of the data, and the channel of the SL.

Alternatively or in addition, the duration of the sensing window may be shorter if the transmission requirement is indicative of a first latency requirement or a first PDB as compared to if the transmission requirement is indicative of a second latency requirement or a second PDB that is greater than the first latency requirement or the first PDB.

Alternatively or in addition, the duration of the sensing window may be longer if the transmission requirement is indicative of a first priority of the data as compared to if the transmission requirement is indicative of a second priority of the data that is lower than the first latency requirement or the first PDB.

Examples of the transmission requirement comprise a latency requirement, a packet delay budget (PDB), a Quality of Service (QOS), a QoS Class Identifier (QCI), a 5G QoS Identifier (5QI), a priority (e.g., a priority of the transmitting radio device, a priority of the data, or a priority of the service underlying the data), a channel congestion metric, a re-selection operation, a pre-emption operation, a capability of the transmitting radio device and/or at least one of or each of the one or more receiving radio devices, a hybrid automatic repeat request (HARQ) status of the data, a HARQ-based re-transmission, and a blind re-transmission.

At least some embodiments can determine (e.g., select, control, and/or regulate) the duration of the sensing window based on the transmission requirement. The transmission requirement may comprise one or more transmission parameters for the transmission of the data on the SL. Same or further embodiments can determine the duration of the sensing window to ensure that the data is given the appropriate QoS treatment (e.g., the QoS of the data), as an example of the transmission requirement.

Without limitation, for example in a 3GPP implementation, any “radio device” may be a user equipment (UE). The SL may be implemented using proximity services (ProSe), e.g. according to a 3GPP specification.

The technique may be implemented as a method of resource allocation. Alternatively or in addition, the technique may be implemented using a partial sensing mechanism or as an extension of a partial sensing mechanism.

The SL may be implemented using any type of wireless device-to-device (D2D) communication. The technique may be applied in the context of 3GPP New Radio (NR). The SL may be a SL of NR. Unlike a SL according to 3GPP LTE, a SL according to 3GPP NR can provide a wide range of QoS levels as an example of the transmission requirement. Therefore, at least some embodiments of the technique can ensure that the transmitting radio device transmits the data in fulfilment of the QoS associated with the data.

The technique may be implemented in accordance with a 3GPP specification, e.g., for 3GPP release 17. The technique may be implemented for 3GPP LTE or 3GPP NR according to a modification of the 3GPP document TS 23.303, version 16.0.0 or for 3GPP NR according to a modification of the 3GPP document TS 33.303, version 16.0.0.

The SL may enable a direct radio communication between proximal radio devices, e.g., the transmitting radio device and the one or more receiving radio devices, optionally using a PC5 interface. Services provided using the SL or the PC5 interface may be referred to as proximity services (ProSe). Any radio device (e.g., the transmitting radio device and/or the one or more receiving radio devices) supporting a SL may be referred to as ProSe-enabled radio device.

The transmitting radio device may function as a relay radio device between the RAN and the one or more receiving radio devices. For data that is unicasted or groupcasted in the downlink (DL) from the RAN to the one or more receiving radio devices, the transmitting radio device may map a QoS class identifier (QCI) of the EPS bearer into a ProSe Per-Packet Priority value to be applied as the transmission requirement (e.g., for the DL relayed unicast packets over the interface PC5 as the SL and/or according to 3GPP document TS 23.303, version 16.0.0, clause 5.4.6.2). The mapping rules may be provisioned in the transmitting radio device.

In any radio access technology (RAT), the technique may be implemented for relaying the data from the transmitting radio device as a remote radio device through the one or more receiving radio devices as one or more relay radio devices to the RAN. Alternatively or in addition, the technique may be implemented for relaying the data from the RAN through the transmitting radio device as a relay radio device to the one or more receiving radio devices as one or more remote radio devices. The relay radio device and the RAN may be wirelessly connected in an uplink (UL) and/or a downlink (DL) through a Uu interface.

Any radio device may be a user equipment (UE), e.g., according to a 3GPP specification. The transmitting radio device may also be referred to as a transmitting UE (or briefly: transmitter). Alternatively or in addition, the one or more receiving radio devices may also be referred to as one or more receiving UEs (or briefly: receivers).

The transmitting radio device and/or the one or more receiving radio devices and/or the RAN may form, or may be part of, a radio network, e.g., according to the Third Generation Partnership Project (3GPP) or according to the standard family IEEE 802.11 (Wi-Fi). The method aspect may be performed by one or more embodiments of the transmitting radio device.

The RAN may comprise one or more network nodes (e.g., base stations). Alternatively or in addition, the radio network may be a vehicular, ad hoc and/or mesh network comprising two or more radio devices, e.g., acting as the transmitting radio device and/or the one or more receiving radio devices.

Any of the radio devices may be a 3GPP user equipment (UE) or a Wi-Fi station (STA). Any of the radio devices may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more network nodes (e.g., base stations). The base station may encompass any station that is configured to provide radio access to any of the transmitting and/or receiving radio devices. The base stations may also be referred to as cell, transmission and reception point (TRP), radio access node or access point (AP). The base station and/or the relay radio device may provide a data link to a host computer providing the user data to the remote radio device or gathering user data from the remote radio device. Examples for the base stations may include a 3G base station or Node B (NB), a 4G base station or eNodeB (eNB), a 5G base station or gNodeB (gNB), a Wi-Fi AP and a network controller (e.g., according to Bluetooth, ZigBee or Z-Wave).

The RAN and/or the SL may be implemented according to 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a device aspect, a device for performing a transmission on a sidelink (SL) from the transmitting radio device to one or more receiving radio devices is provided. The radio device comprises memory operable to store instructions and processing circuitry operable to execute the instructions, such that the radio device is, upon arrival of data for the transmission on the SL, operable to sense a channel of the SL during a sensing window. A duration of the sensing window depends on a transmission requirement associated with the data. The radio device is, based on a result of the sensing of the channel during the sensing window, further operable to select resources of the channel in a resource selection window for the transmission of the data.

The radio device may be further operable to perform any of the steps of the method aspect.

As to a further device aspect, a radio device for performing a transmission on a sidelink (SL) from the transmitting radio device to one or more receiving radio devices is provided. The radio device is configured to sense, upon arrival of data for the transmission on the SL, a channel of the SL during a sensing window. A duration of the sensing window depends on a transmission requirement associated with the data. The radio device is further configured to select, based on a result of the sensing of the channel during the sensing window, resources of the channel in a resource selection window for the transmission of the data.

The radio device may be further configured to perform any of the steps of the method aspect.

As to a still further device aspect, a user equipment (UE) configured to communicate with a network node or with a radio device functioning as a gateway is provided. The UE comprises a radio interface and processing circuitry configured to sense a channel of the SL during a sensing window upon arrival of data for the transmission on the SL. A duration of the sensing window depends on a transmission requirement associated with the data. The processing circuitry is further configured to select resources of the channel in a resource selection window for the transmission of the data based on a result of the sensing of the channel during the sensing window.

The processing circuitry may be further configured to execute any steps of the method aspect.

In any device aspect, the device may be configured to perform any one of the steps of the method aspect. Alternatively or in addition, the device may comprise processing circuitry (e.g., at least one processor and a memory). Said memory comprises instructions executable by said at least one processor whereby the device is operative to perform any one of the steps of the first method aspect.

As to a still further aspect, a communication system including a host computer is provided. The host computer comprises a processing circuitry configured to provide user data, e.g., included in the data of the transmission. The host computer further comprises a communication interface configured to forward the data to a cellular network (e.g., the RAN and/or the base station) for transmission to a UE (e.g., the transmitting radio device). The UE comprises a radio interface and processing circuitry, which is configured to execute any one of the steps of the method aspect.

The communication system may further include the UE. Alternatively, or in addition, the cellular network may further include one or more base stations configured for radio communication with the UE and/or to provide a data link between the UE and the host computer using the method aspect.

The processing circuitry of the host computer may be configured to execute a host application, thereby providing the data and/or any host computer functionality described herein. Alternatively, or in addition, the processing circuitry of the UE may be configured to execute a client application associated with the host application.

Any one of the devices, the transmitting radio device, the UE, the base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for performing a transmission on a SL from a transmitting radio device to one or more receiving radio devices;

FIG. 2 shows a flowchart for a method of performing a transmission on a SL from a transmitting radio device to one or more receiving radio devices, which method may be implementable by the device of FIG. 1;

FIG. 2.1 shows a flowchart for a method of performing a transmission on a SL from a transmitting radio device to one or more receiving radio devices, which method may be a variant of the method of FIG. 2 and/or which method may be implementable by the device of FIG. 1;

FIG. 3 schematically illustrates an example of a radio network comprising one or more embodiments of the device of FIG. 1 for performing the method of FIG. 2 or 2.1;

FIG. 4 schematically illustrates a first example of a sensing window and a resource selection window, which may be used by an embodiment of the device of FIG. 1 at least in some situations;

FIG. 5 schematically illustrates a second example of a sensing window and a resource selection window, which may be used by an embodiment of the device of FIG. 1 at least in some situations;

FIG. 6 schematically illustrates a third example of a sensing window and a resource selection window, which may be used by an embodiment of the device of FIG. 1 at least in some situations;

FIG. 7 shows a schematic block diagram of a transmitting radio device embodying the device of FIG. 1;

FIG. 8 schematically illustrates an example telecommunication network connected via an intermediate network to a host computer;

FIG. 9 shows a generalized block diagram of a host computer communicating via a base station or the transmitting radio device functioning as a gateway with a user equipment over a partially wireless connection; and

FIGS. 10 and 11 show flowcharts for methods implemented in a communication system including a host computer, a base station or the transmitting radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

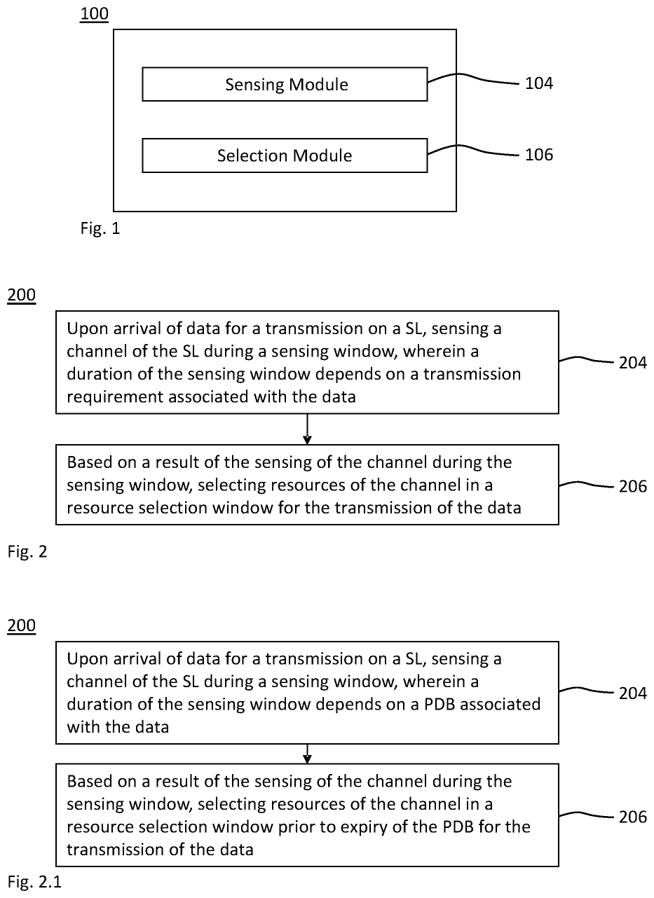

FIG. 1 schematically illustrates a block diagram of an embodiment of a device for performing a transmission on a SL from a transmitting radio device to one or more receiving radio devices. The device is generically referred to by reference sign 100.

The device 100 comprises a sensing module 104 that senses a channel of the SL according to the method aspect. The device 100 further comprises a selection module 106 that selects resources of the channel for the transmission of the data in a resource selection window according to the method aspect.

Any of the modules of the device 100 may be implemented by units configured to provide the corresponding functionality.

The device 100 may also be referred to as, or may be embodied by, the transmitting radio device 100-T (or briefly: transmitter). The transmitting radio device 100-T and the one or more receiving radio devices may be in direct radio communication, e.g., at least for the transmission of the data on the channel of the SL from the transmitting radio device 100 to the one or more receiving radio devices. The one or more receiving radio devices are referred to by reference sign 100-R. Any of the radio devices may function as both receiving radio device and transmitting radio device, e.g., in a bidirectional communication of the data.

FIG. 2 shows an example flowchart for a method 200 of performing a transmission on a SL from a transmitting radio device to one or more receiving radio devices. In a step 204, upon arrival of data for the transmission on the SL, a channel of the SL is sensed during a sensing window. A duration of the sensing window depends on a transmission requirement associated with the data. Alternatively or in addition, the method 200 comprises or initiates a step 204 of sensing, upon arrival of data for the transmission on the SL, a channel of the SL during a sensing window, wherein a duration of the sensing window depends on a packet delay budget (PDB) associated with the data, e.g., as illustrated in FIG. 2.1.

In a step 206 of the method 200, based on a result of the sensing 204 of the channel during the sensing window, resources of the channel are selected in a resource selection window for the transmission of the data. Alternatively or in addition, the method 200 comprises or initiates a step 206 of selecting, based on a result of the sensing of the channel during the sensing window, resources of the channel in a resource selection window prior to expiry of the PDB for the transmission of the data, e.g., as illustrated in FIG. 2.1.

Optionally, the data arrives (e.g., at the device 100-T) in a step 202 of the method 200. Alternatively or in addition, the data is transmitted using the selected resource (e.g., a slot in the time domain of the channel) in a step 208 of the method 200.

The method 200 may be performed by the device 100-T. For example, the modules 104 and 106 may perform the steps 204 and 206, respectively.

The technique may be applied to direct communications between radio devices, e.g., device-to-device (D2D) communications, which are examples of the transmission on the SL. The SL may be independent of a RAN. Alternatively or in addition, the SL may extend an uplink (UL) from the transmitting radio device through the one or more receiving radio devices acting as relay radio devices to the RAN, and/or the SL may extend a downlink (DL) from the RAN through the transmitting radio device acting as a relay radio device to the one or more receiving radio devices.

Each of the transmitting radio device 100-T and receiving radio device 100-R may be a radio device. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). The transmitting and receiving radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR).

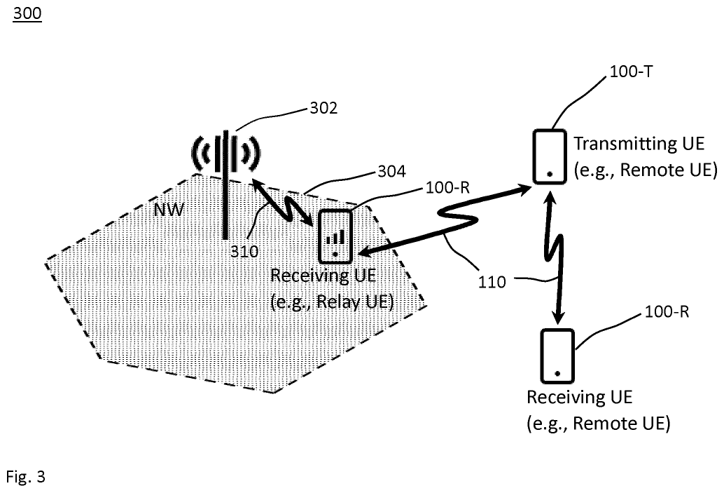

FIG. 3 schematically illustrates an example of a radio network 300. The radio network 300 may or may not comprise a radio access network comprising one or more network nodes 302. If so, each network node 302 (e.g., a base station) may provide radio access to any of the transmitting or receiving radio devices 100-T and/or 100-R in one or more cells 304. The radio interface 310 between the network node 302 and the radio device 100-T or 100-R (as illustrated in FIG. 3) may be a 3GPP Uu interface.

Alternatively or in addition, the radio network 300 comprising one or more embodiments of the device 100-T for performing the method 200. The radio interface 110 between the transmitting radio device 100-T and the one or more receiving radio device 100-R may be a SL 110.

Optionally, the transmitting radio device 100-T may transmit the data to the network node 302 using one of the one or more receiving radio devices 100-R as a relay radio device. Alternatively or in addition, the network node 302 may transmit the data to any one of the one or more receiving radio devices 100-R using an embodiment of the transmitting radio device 100-T in a cell 304 of the network node 302 as a relay radio device.

For concreteness and not limitation, embodiments of the technique are described referring to the radio devices as UEs or SL UEs.

A resource on the channel for the SL may be allocation for SL transmissions, which is referred to as resource allocation. As for the SL of LTE, there are two modes for the resource allocation for the SL of NR.

A first mode comprises a network-based resource allocation, in which the network (e.g., the network node 302) selects (e.g., controls) the resources and/or other transmit parameters used by the SL UEs 100-T and 100-R. In some cases, the network may control every single transmission parameter. In other cases, the network may select the resources used for transmission but may give the transmitter 100-T the freedom to select some of the transmission parameters, possibly with some restrictions. In the context of NR SL, 3GPP refers to this resource allocation mode as mode 1.

A second mode comprises autonomous resource allocation, in which the UEs 100-T and/or 100-R autonomously select the resources and/or other transmit parameters. In this mode, there may be no intervention by the network (e.g., out of coverage, unlicensed carriers without a network deployment, etc.) or very minimal intervention by the network (e.g., configuration of pools of resources, etc.). In the context of NR SL, 3GPP refers to this resource allocation mode as mode 2 (also referred to as transmission mode 2).

The technique may be particularly implemented by the device 100-T, operations, and the method 200 using resource allocation mode 2 or any other mode in which the UE 100-T and/or one or more UEs 100-R perform the sensing 204 and the resource selection 206 (i.e., resource allocation).

The steps 204 and/or 206 may be implemented using mode 2 of the SL 110 (also referred to as SL transmission mode 2) according to 3GPP NR.

In transmission mode 2 of the SL 110, distributed resource selection 206 is employed, i.e., there is no central node 302 for scheduling and/or the UEs 100-T and/or 100-R may play the same (e.g., equal) role in autonomous resource selection 206. Transmission mode 2 is based on two functionalities: reservation of future resources (e.g., performed by the one or more UEs 100-R) and sensing-based resource allocation (e.g., performed by the UE 100-T in the steps 204 and 206).

Reservation of future resources is done so that a UE (which may one of the UEs 100-R) transmitting data (e.g., a message) also notifies the receivers of this transmission (which may include the UE 100-T) about its intention to transmit using certain time-frequency resources at a later point in time. For example, a UE transmitting at time T informs the receivers that it will transmit using the same frequency resources at time T+100 ms. Resource reservation allows the UE 100-T to predict the utilization of the radio resources in the future. That is, by listening to the current transmissions of another UE (e.g., the one or more UEs 100-R) in the step 204, the UE 100-T also obtains information about potential future transmissions.

This information can be used by the UE 100-T to avoid collisions when selecting its own resources in the step 206. Optionally, the UE 100-T predicts the future utilization of the radio resources by reading received booking messages as an example of the sensing in the step 204 and then schedules its current transmission to avoid using the same resources as an example of the selecting in the step 206. The steps 204 and 206 are also referred to as sensing-based resource selection.

The steps may use or extend the sensing-based resource selection scheme specified in 3GPP Release 16 (for NR). The sensing-based resource selection scheme can be implemented (e.g., on a general functional level) using at least one of the following allocation steps and/or defined in the specification TS 38.214, version 16.1.0.

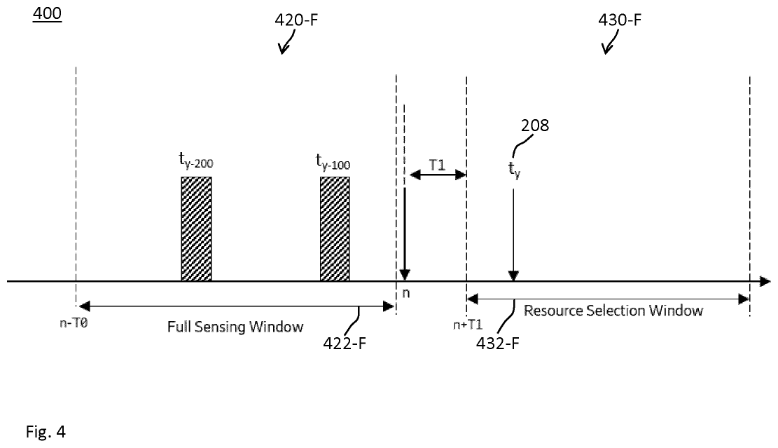

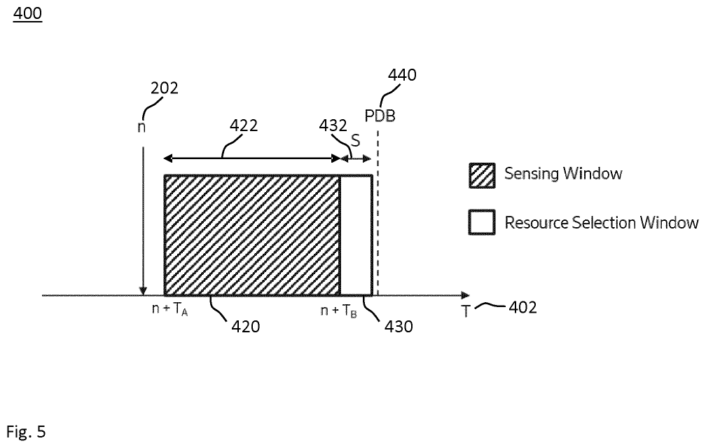

In a first allocation step (e.g., the step 204), the UE 100-T senses the channel (i.e., a transmission medium of the SL 110) during an interval [n−a, n−b] in the step 204, wherein n is a time reference, and a>b≥0 define the duration (generically referred to by reference sign 422) of the sensing window 420, different examples of which are illustrated in each of the FIGS. 4, 5, and 6. Conventionally, the length of the sensing window 422-F may configurable or pre-configurable. In the step 204, the duration 422 may be reduced depending on the transmission requirement.

In a second allocation step (e.g., the step 204 and/or 206), based on the result of the sensing 204 (also referred to as sensing results), the UE 100-T predicts the future utilization of the channel (e.g., the transmission medium) at a future time interval [n+T₁, n+T₂], wherein T₂>T₁≥0. The interval [n+T₁, n+T₂] is the resource selection window (generically referred to by reference sign 430).

In a third allocation step (e.g., the step 206), the UE 100-T selects one or more time-frequency resources among the resources in the selection window [n+T₁, n+T₂] that are predicted and/or determined to be selectable (e.g., idle, usable, available, etc.).

The sensing-based resource selection 204 and 206 may be implemented according to a 3GPP specification for Release 16 related to resource selection in NR mode 2. Alternatively or in addition, sensing-based resource selection 204 and 206 may be implemented using at least one of the steps of the specification in below box related to the sensing window 420 and/or the selection window 430. For example, the sensing window 420 may be defined according to Step 2 in the below box. Alternatively or in addition, the resource selection window 430 may correspond to the time interval [n+T₁, n+T₂], as described in the Step 1 in the below box.

| | |
|---|---|
| 8.1.4 | UE procedure for determining the subset of resources to be reported to higher |
| | layers in PSSCH resource selection in sidelink resource allocation mode 2 |

In resource allocation mode 2, the higher layer can request the UE to determine a subset of resources from
which the higher layer will select resources for PSSCH/PSCCH transmission. To trigger this procedure, in
slot n, the higher layer provides the following parameters for this PSSCH/PSCCH transmission:

| the resource pool from which the resources are to be reported; | |
|---|---|
| L1 priority, prio_{TX}; | |
| the remaining packet delay budget; | |
| the number of sub-channels to be used for the PSSCH/PSCCH transmission in a slot, L_{subCH}; | |
| optionally, the resource reservation interval, Pᵣₛᵥₚ_TX, in units of ms. | |
| if the higher layer requests the UE to determine a subset of resources from which the higher layer will | |
| select resources for PSSCH/PSCCH transmission as part of re-evaluation or pre-emption procedure, | |
| the higher layer provides a set of resources (r₀, r₁, r₂, . . . ) which may be subject to re-evaluation and a | |
| set of resources (r₀', r₁', r₂', . . . ) which may be subject to pre-emption. | |
| | it is up to UE implementation to determine the subset of resources as requested by higher layers |
| | before or after the slot rᵢ″ − T₃, where rᵢ″ is the slot with the smallest slot index among |
| | (r₀, r₁, r₂, . . . ) and (r₀', r₁', r₂', . . . ) , and T₃ is equal to T_{proc,1}^{SL}, where T_{proc,1}^{SL} is defined in slots in |
| | Table 8.1.4-2 where μ_{SL} is the SCS configuration of the SL BWP. |

The following higher layer parameters affect this procedure:

t2min_SelectionWindow: internal parameter T₂ₘᵢₙ is set to the corresponding value from higher layer
parameter t2min_SelectionWindow for the given value of prio_{TX}.
SL-ThresRSRP_pi_pj: this higher layer parameter provides an RSRP threshold for each combination
(pᵢ, pⱼ), where pᵢ is the value of the priority field in a received SCI format 1-A and pⱼ is the priority
of the transmission of the UE selecting resources; for a given invocation of this procedure, pⱼ =
prio_{TX}.
RSforSensing selects if the UE uses the PSSCH-RSRP or PSCCH-RSRP measurement, as defined in
clause 8.4.2.1.
sl-ResourceReservePeriodList
t0_SensingWindow: internal parameter T₀ is defined as the number of slots corresponding to
t0_SensingWindow ms.
sl-xPercentage: internal parameter X for a given prio_{TX} is defined as sl-xPercentage(prio_{TX})
converted from percentage to ratio
p_preemption: internal parameter prioₚᵣₑ is set to the higher layer provided parameter p_preemption

The resource reservation interval, Pᵣₛᵥₚ_TX, if provided, is converted from units of ms to units of logical
slots, resulting in Pᵣₛᵥₚ_TX' according to clause 8.1.7.
Notation:
(t₀^{SL}, t₁^{SL}, t₂^{SL}, . . . ) denotes the set of slots which can belong to a sidelink resource pool and is defined in
Clause 8.
The following steps are used:

| 1) | A candidate single-slot resource for transmission R_{x,y} is defined as a set of L_{subCH} contiguous sub- | |
|---|---|---|
| | channels with sub-channel x + j in slot t_{y}^{SL} where j = 0, . . . , L_{subCH} − 1. The UE shall assume that any | |
| | set of L_{subCH} contiguous sub-channels included in the corresponding resource pool within the time | |
| | interval [n + T₁, n + T₂] correspond to one candidate single-slot resource, where | |
| | | selection of T₁ is up to UE implementation under 0 ≤ T₁ ≤ 1_{proc,1}^{SL} , where T_{proc,1}^{SL} is defined in |
| | | slots in Table 8.1.4-2 where μ_{SL} is the SCS configuration of the SL BWP; |
| | | if T₂ₘᵢₙ is shorter than the remaining packet delay budget (in slots) then T₂ is up to UE |
| | | implementation subject to T₂ₘᵢₙ ≤ T₂ ≤ remaining packet budget (in slots); otherwise T₂ is set to |
| | | the remaining packet delay budget (in slots). |
| | The total number of candidate single-slot resources is denoted by Mₜₒₜₐₗ. | |
| 2) | The sensing window is defined by the range of slots [n − T₀, n − T_{proc,0}^{SL}) where T₀ is defined above and | |
| | T_{proc,0}^{SL} is defined in slots in Table 8.1.4-1 where μ_{SL} is the SCS configuration of the SL BWP. The UE | |
| | shall monitor slots which can belong to a sidelink resource pool within the sensing window except for | |
| | those in which its own transmissions occur. The UE shall perform the behavior in the following steps | |
| | based on PSCCH decoded and RSRP measured in these slots. | |
| 3) | The internal parameter Th(pᵢ) is set to the corresponding value from higher layer parameter SL- | |
| | ThresRSRP_pi_pj for pⱼ equal to the given value of prio_{TX} and each priority value pᵢ. | |
| 4) | The set S_{A} is initialized to the set of all the candidate single-slot resources. | |
| 5) | The UE shall exclude any candidate single-slot resource R_{x,y} from the set S_{A} if it meets all the | |
| | following conditions: | |
| | | the UE has not monitored slot tₘ^{SL} in Step 2. |
| | | for any periodicity value allowed by the higher layer parameter sl-ResourceReservePeriodList and |
| | | a hypothetical SCI format 1-A received in slot tₘ^{SL} with “Resource reservation period” field set to |
| | | that periodicity value and indicating all subchannels of the resource pool in this slot, condition c in |
| | | step 6 would be met. |
| 6) | The UE shall exclude any candidate single-slot resource R_{x,y} from the set S_{A} if it meets all the | |
| | following conditions: | |
| | a) | the UE receives an SCI format 1-A in slot tₘ^{SL}, and “Resource reservation period” field, if present, |
| | | and “Priority” field in the received SCI format 1-A indicate the values Pᵣₛᵥₚ_RX and prio_{RX}, |
| | | respectively according to Clause 16.4 in 3GPP document TS 38.213, version 16.5.0; |
| | b) | the RSRP measurement performed, according to clause 8.4.2.1 for the received SCI format 1-A, is |
| | | higher than Th(prio_{RX}); |
| | c) | the SCI format received in slot tₘ^{SL} or the same SCI format which, if and only if the “Resource |
| | | reservation period” field is present in the received SCI format 1-A, is assumed to be received in |
| | | slot(s) t_{m+q×P}_{ᵣₛᵥₚ}_RX_{'}^{SL} determines according to clause 8.1.5 the set of resource blocks and slots |
| | | which overlaps with R_{x,y+j×P}_{ᵣₛᵥₚ}_TX_{'} for q = 1, 2, . . . , Q and j = 0, 1, . . . , Cᵣₑₛₑₗ − 1. Here, Pᵣₛᵥₚ_RX' is |
| | | ${P}_{rsvp \_ RX} converted to units of logical slots according to clause 8.1 \text{.7} , Q = ⌈ \frac{{T}_{scal}}{{P}_{rsvp \_ RX}} ⌉ if {P}_{rsvp \_ RX} <$ |
| | | T_{scal} and n' − m ≤ Pᵣₛᵥₚ_RX, where t_{n'}^{SL} = n if slot n belongs to the set (t₀^{SL}, t₁^{SL}, . . ., t_{T}_{ₘₐₓ}^{SL}), |
| | | otherwise slot t_{n'}^{SL} is the first slot after slot n belonging to the set (t₀^{SL}, t₁^{SL}, . . ., t_{T}_{ₘₐₓ}^{SL}); otherwise |
| | | Q = 1 · T_{scal} is set to selection window size T₂ converted to units of ms. |

| | |
|---|---|
| 7) | If the number of candidate single-slot resources remaining in the set SA is smaller than X · Mₜₒₜₐₗ, then |
| | Th(pᵢ) is increased by 3 dB for each priority value Th(pᵢ) and the procedure continues with step 4. |

The UE shall report set S_{A} to higher layers.

Alternatively or in addition, the device 100-T and/or the method 200 may use partial sensing, e.g., a partial sensing mechanism in LTE or NR, in the step 204 and/or the step 206.

For the SL 110 in LTE, two procedures for resource selection (e.g., in transmission mode 4) with reduced power consumption were introduced in Release 15: partial sensing and random selection for pedestrian UEs. In case of partial sensing, the pedestrian UE 100-T uses a reduced selection window 420 which is a subset of the selection window 420-F used by performing normal sensing. Using this mechanism, only a sub-set of subframes is sensed (i.e., monitored) during the sensing window, i.e., 1 sec in LTE, which leads to a power consumption reduction due to the shorter time duration of the sensing 204. In this way, partial sensing allows for reducing power consumption at the expense of an increase in resource collision probability in the step 206. The increase in resource collision probability is due to the fact that the UE 100-T is not able to collect the complete channel occupancy information as the result of the sensing 204 due to the reduced sensing window 420.

FIG. 4 schematically illustrates an example of the partial sensing mechanism, e.g. in LTE

When partial sensing is configured or pre-configured for a resource pool, the UE 100-T can perform reduced sensing in the step 204 depending on the transmission requirement, i.e. at limited sensing occasions, within the sensing full sensing window 420-F, which as mentioned before may be 1 sec in LTE. An example of the operation in LTE is shown in FIG. 4. The sensing occasions (i.e., the reduced sensing windows 420) are determined considering the periodic nature of the data traffic. For example, the sensing 204 is performed periodically repeating with a step of 100 ms as determined by t_{y-200} and t_{y-100}. These instants in time to perform the partial sensing operation (e.g., the beginning of the respective sensing window 420 reduced depending on the transmission requirement) are defined from (i.e., relative to) the instant t_{y}, which is the slot or subframe selected by the UE 100-T in the step 206. It may be up to UE implementation as long as it is within the resource selection window.

For each transmission pool, resource selection mechanism (i.e. random selection, partial sensing-based selection or either random selection or partial sensing-based selection), which is allowed to be used in this pool, is also configured. If UE is configured to use either random selection or partial sensing-based selection for one transmission pool, it is up to UE implementation to select a specific resource selection mechanism. If the UE is configured to use partial sensing-based selection only, the UE shall use partial sensing-based selection in the pool. The UE shall not do random selection in the pool wherein only partial sensing is allowed. If the eNB does not provide a random selection pool, the UEs that support only random selection cannot perform sidelink transmission. In exceptional pool, the UE uses random selection. The UE can transmit SL UE Information message to indicate that it requests resource pools for P2X-related V2X sidelink communication transmission as specified in the 3GPP document TS 36.331, version 16.4.0.

FIG. 5 schematically illustrates an example of the steps 204 and 206 using a resource allocation procedure with limited resource selection window.

In existing (e.g., contiguous) partial sensing operation, a sensing window 420-F is defined as a fixed size, however, the packet delay budget (PDB) of the packet to be transmitted varies depending on the transmission requirement, e.g., latency requirements. Given the fixed size of sensing window 420-F, it may not be possible to perform the packet transmission within the PDB (e.g., the end of the PDB at reference sign 440). For example, if the PDB is small then it may lead to the situation that the (e.g., remaining or residual) resource selection window 430 (e.g., before the PDB expires) is not sufficiently large for the given packet priority, e.g. as is schematically illustrated at reference sign 430 in the FIG. 5.

In FIG. 5, the sensing window 420 defined as [n+T_{A}, n+T_{B}] covers most of the time between the time n when the transmission is triggered (e.g., upon arrival of the data) and the maximum delay for transmission defined by the PDB 440. Therefore, the duration 432 (labelled “S”) of the resource selection window 430 is not big enough so that the UE 100-T can find suitable resources for transmission 208 prior to the expiration 440 of the PDB budget.

As an embodiment of the device 100-T performing the method 200, optionally in combination or extension of the features described above (e.g., with reference to FIG. 4 or 5), the duration 422 of the sensing window 420 (i.e., a sensing window size) is adjusted based on the transmission requirement associated with the data, e.g., a delay budget (i.e., a PDB) of the associated transmission, in order to allow the UE 100-T to have enough time, i.e., a minimum size (i.e., a minimum duration) of the resource selection window 430, in order to perform the resource selection 206 in fulfilment of the transmission requirement, e.g., before the PDB 440 is met (i.e., expires). The duration 432 of the resource selection window 430 (e.g., the minimum duration of the resource selection window 430) may include time for one or more potential re-transmissions of the data.

The duration 422 (i.e., the size) of the sensing window 420, e.g., along with (e.g., the sum of) the minimum required duration 432 (i.e., size) for the resource selection window 430 can be defined depending on the transmission requirement, i.e., as a function of the transmission requirement. The transmission requirement may comprise different parameters associated to the transmission, e.g., a PDB of the transmission, a priority of the transmission, etc.

Alternatively or in addition, the sensing window size 422 may be defined and/or adjusted in the step 204 depending on the transmission requirement, e.g., based on different parameters which are related to the associated SL transmission 208.

Any embodiment of the technique may be implemented as a mechanism for determining the duration 422 (i.e., the size) of the sensing window 420. The sensing 204 may include or may relate to a sensing related to a (e.g., potential) re-evaluation or pre-emption operation, e.g., associated to a SL transmission 208. That is, the transmission requirement may include a re-evaluation or pre-emption operation. By determining the duration 422 of the sensing window 420 depending on the transmission requirement (e.g. in case of a re-evaluation or pre-emption operation), at least a minimum duration 432 (i.e., size) of the resource selection window 430 required to perform the resource selection 206 is achieved. The duration 422 of the sensing window 420 and/or the duration 432 of the resource selection window 430 may be defined based on the transmission requirement, e.g., one or more transmission parameters associated to the SL transmission 208 such as PDB, priority, etc.

In any embodiment, the UE 100-T may trigger the sensing step 204 (i.e., its sensing operation) upon receiving a data packet from higher layers at a point in time n (as an example of the arrival of the data). Therefore, e.g., without loss of generality, the sensing window 420 may be defined or implemented as [n+T_{A}, n+T_{B}], wherein T_{A} may be related to the processing time needed to start the sensing operation 204 and/or T_{B} is the ending time of the sensing window 420.

After performing the sensing operation 204, the UE 100-T performs the selecting step 206 (i.e., its resource selection operation). The one or more resources selected (e.g., for initial transmission and/or for a potential re-transmission) must fall within the window [n+T_{B}, n+PDB], wherein PDB is the (e.g., remaining) packet delay budget, i.e., the maximum time the UE 100-T can take to perform the resource selection 206 and/or the transmission 208.

Herein, the time of expiry, n+PDB, of the PDB is also referred to by the reference sign 440.

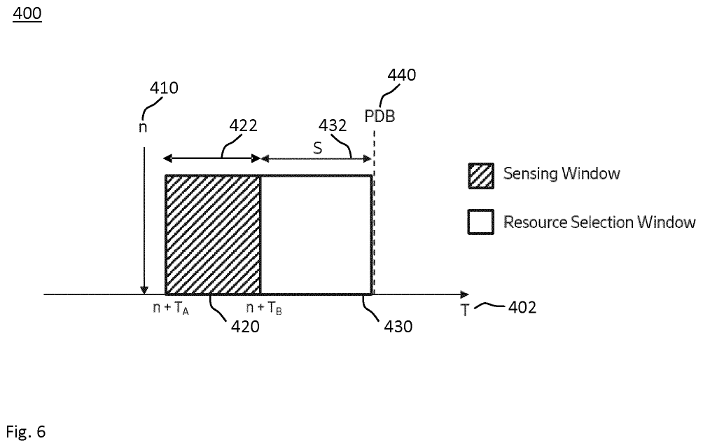

FIG. 6 shows an exemplary resource allocation according to the steps 204 and 206 including the sensing window 420 and the resource selection window 430. In some cases or situation (e.g., depending on the transmission requirement), it may not be desirable to extend the selection window 206 all the way to the end of the PDB 440, and thus an earlier end may be chosen.

One of the aspects to be considered is that the UE 100-T needs sufficient time, i.e., the duration 432 of the resource selection window 430, in order to select resources to perform the SL transmission 208. Therefore, it is required to determine (e.g., regulate and/or adjust) the duration 422 of the sensing window 420 depending on the transmission requirement, e.g., based on the required duration 432 of the resource selection window 430 and/or other parameters, in order to obtain a feasible resource allocation procedure 206. That is, a balance between both windows 420 and 430 is necessary.

Under some conditions, the duration 422 of the sensing window 420 may be zero, i.e., there is (e.g., effectively) no sensing operation 204. Alternatively or in addition, the resource selection window 430 must have a minimum length in order for the UE 100-T to perform the resource selection 206.

In a detailed embodiment, the duration 422 of the sensing window, i.e., [n+T_{A}, n+T_{B}], may be adjusted using at least one of the following formulations or functional dependencies:

duration 422 of the sensing window 420=f(transmission requirement).

More specifically,

duration 422 of the sensing window 420=f(PDB,duration 432 of the resource selection window 430, [other parameters]).

or

duration 422 of the sensing window 420=f(PDB,minimum duration of the resource selection window 430, [other parameters]).

The transmission requirement may comprise the PDB (e.g., the time remaining until expiry of the PDB), the duration 432 of the resource selection window 430, a minimum of the duration 432 of the resource selection window 430, and/or other parameters related to the data and/or the transmission 208 and/or the channel of the SL 110.

For example, the transmission requirement may comprise, or may be indicative of, at least one of the following parameters.

The transmission requirement may comprise or may be indicative of the PDB. The PDB is the packet delay budget of the transmission 208 (or the remaining PDB at the time of executing the method 200). Based on the PDB, the sensing window 420 can be shorter, i.e., for low latency transmissions, or longer, i.e., for non-latency critical transmissions, in order to accommodate the selection window while obtaining enough sensing results.

The transmission requirement may comprise or may be indicative of the resource selection window 430 or the duration 432 of the resource selection window 430.

There may be a minimum duration needed for the UE 100-T in order to be able to perform the resource selection procedure 206. The minimum size needed for the UE for resource selection may dependent on the priority of the data packet to be transmitted, e.g., according to procedures of 3GPP Release 16.

The transmission requirement may comprise or may be indicative of one or more other parameters. The one or more other parameters may comprise at least one of the following parameters.

A first parameter comprises a priority of the data. Based on the priority of the data (e.g., a data packet) to be transmitted, the sensing window 420 can be longer, e.g., for high priority transmissions, or shorter if the priority of the data packet to be transmitted is low.

A second parameter comprises a channel congestion metric (e.g., channel busy ration, CBR). Based on the channel congestion, the sensing window may be longer for high congestion (i.e. CBR is high) or shorter if the congestion is low (i.e. CBR is low).

A third parameter comprises a re-selection operation and/or a pre-emption operation. Upon performing the sensing operation 204 (or without sensing operation) and performing the resource selection operation 206, the UE 100-T may trigger or be triggered by signaling, e.g., based on coordination message from a peer UE 100-R, to perform additional sensing, i.e., re-evaluation, which may limit the duration 432 of the resource selection window 430.

A fourth parameter comprises a UE capability. The duration 422 may be based on the procedural times for the UE 100-T in order to start and/or perform the sensing operation 204 or the resource selection operation 206.

A fifth parameter comprises a HARQ-based re-transmission and/or a blind re-transmission. In case the transmission has HARQ-enabled, the sensing window 420 may be determined (e.g., adjusted or reduced) in order to accommodate the re-transmissions which are simultaneously reserved.

The technique has been described and disclosed in terms of determining the sensing window 420 (or a parameter thereof, e.g., size 422, its endpoints, etc.) as a function of the transmission requirement, e.g., the selection window 430 (or a parameter thereof, e.g., size 430, its endpoints, etc.), the PDB 440, and/or other parameters. Furthermore, the technique may also be implemented and/or is also applicable for determining the selection window 430 (or a parameter thereof) as a function of the sensing window 420 (or a parameter thereof), PDB 440, and other parameters.

The technique may be realized by any of the following exemplary embodiments, alone or in combination with any of the above described embodiments and/or any embodiment in the list of embodiments.

In a first exemplary embodiment, the duration 422 of the sensing window 420 is based on a minimum required resource selection window 430.

In a second exemplary embodiment, the duration 422 of the sensing window 420 is based on a PDB of the data (e.g., a data packet) to be transmitted.

In a third exemplary embodiment, the duration 422 of the sensing window 420 is based on one or more parameters of the data (e.g., a data packet) to be transmitted, e.g., a priority of the transmission or a HARQ re-transmissions or blind re-transmission.

In a fourth exemplary embodiment, the duration 422 of the sensing window 420 refers to the number of slots in the sensing window 420. The sensing window 420 may be a contiguous interval [n+T_{A}, n+T_{B}]. Alternatively or in addition, the sensing window 420 may comprise of a set of slots, e.g., not necessarily contiguous, e.g., in an interval.

In a fifth exemplary embodiment, the duration 422 of the sensing window 420 is based on one or more other parameters of the UE 100-T and/or the channel of the SL 110, e.g. UE processing times or channel congestions (e.g. measured as CBR etc.)

In a sixth exemplary embodiment, the sensing window 420 or its duration 422 is up to UE implementation within one or more bounds given by the dependency on the transmission requirement. Denoting the duration 422 by Sₛₑₙₛₑ, for example, Sₛₑₙₛₑ≥ S_{sense, min}=f(transmission requirement), wherein the function f represents the dependency on the transmission requirement. In other words, the duration 422 (denoted by Sₛₑₙₛₑ) of the sensing window 420 may be up to UE implementation so far as the duration 422 is larger or equal than the lower bound Sₛₑₙₛₑ, min that depends on the transmission requirement (e.g., according to any of the above examples of the transmission requirement). Alternatively or in addition, the duration 422 (denoted by Sₛₑₙₛₑ) of the sensing window 420 may be up to UE implementation so far as the duration 422 is smaller or equal than the upper bound Sₛₑₙₛₑ, max that depends on the transmission requirement (e.g., according to any of the above examples of the transmission requirement).

In a seventh exemplary embodiment, the duration 422 of the sensing window,

Sₛₑₙₛₑ=PDB−S_{select},

wherein Sₛₑₙₛₑ is the duration 422 of the sensing window 420 and S_{select} is the duration 432 of the selection window 430.

In an eight exemplary embodiment, the duration 422 of the sensing window 420 and the duration 432 of the resource selection window 430 are optimized jointly depending on the transmission requirement, e.g., according to the above-mentioned bounds. Alternatively or in addition, the duration 432 of the resource selection window 430 may be greater than the minimum possible window for the packet to be transmitted and/or retransmitted.

Any of the embodiments may be implemented in accordance with or by extending at least one of the 3GPP documents TS 38.213, version 16.5.0; TS 38.214, version 16.5.0; and TS 38.215, version 16.4.0.

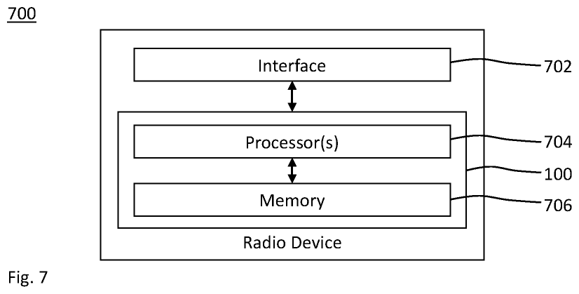

FIG. 7 shows a schematic block diagram for an embodiment of the device 100, e.g., the transmitting radio device 100-T. The device 100 comprises processing circuitry, e.g., one or more processors 704 for performing the method 200 and memory 706 coupled to the processors 704. For example, the memory 706 may be encoded with instructions that implement at least one of the modules 204 and 206.

The one or more processors 704 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 706, transmitter functionality. For example, the one or more processors 704 may execute instructions stored in the memory 706. Such functionality may include providing various features and steps discussed herein, including any of the benefits disclosed herein. The expression “the device being operative to perform an action” may denote the device 100 being configured to perform the action.

As schematically illustrated in FIG. 7, the device 100 may be embodied by a radio device 700, e.g., functioning as a transmitting UE. The transmitting radio device 700 comprises a radio interface 702 coupled to the device 100 for radio communication with one or more receiving radio devices, e.g., functioning as receiving UEs.

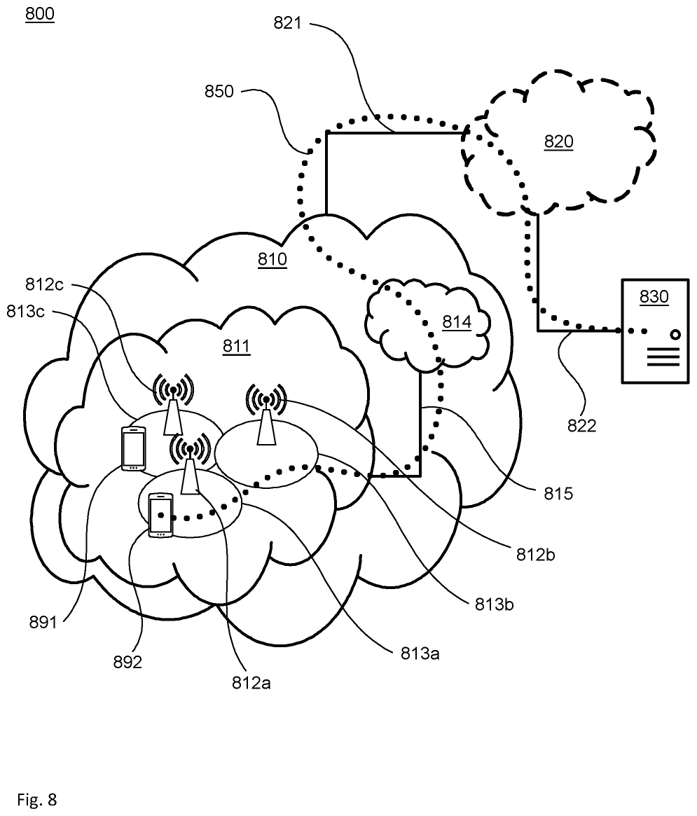

With reference to FIG. 8, in accordance with an embodiment, a communication system 800 includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first user equipment (UE) 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

Any of the base stations 812 and the UEs 891, 892 may embody the device 100.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. The connections 821, 822 between the telecommunication network 810 and the host computer 830 may extend directly from the core network 814 to the host computer 830 or may go via an optional intermediate network 820. The intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system 800 of FIG. 8 as a whole enables connectivity between one of the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, a base station 812 need not be informed about the past routing of an incoming downlink communication with data originating from a host computer 830 to be forwarded (e.g., handed over) to a connected UE 891. Similarly, the base station 812 need not be aware of the future routing of an outgoing uplink communication originating from the UE 891 towards the host computer 830.

By virtue of the method 200 being performed by any one of the UEs 100-T, 891 or 892 and/or initiated or controlled any one of the network nodes 304 or 812 (e.g., base stations), the performance or range of the OTT connection 850 can be improved, e.g., in terms of increased throughput and/or reduced latency and/or QoS. More specifically, the host computer 830 may indicate to the RAN 300 or the transmitting radio device 100-T (e.g., on an application layer) the QoS of the data (i.e., the data traffic).

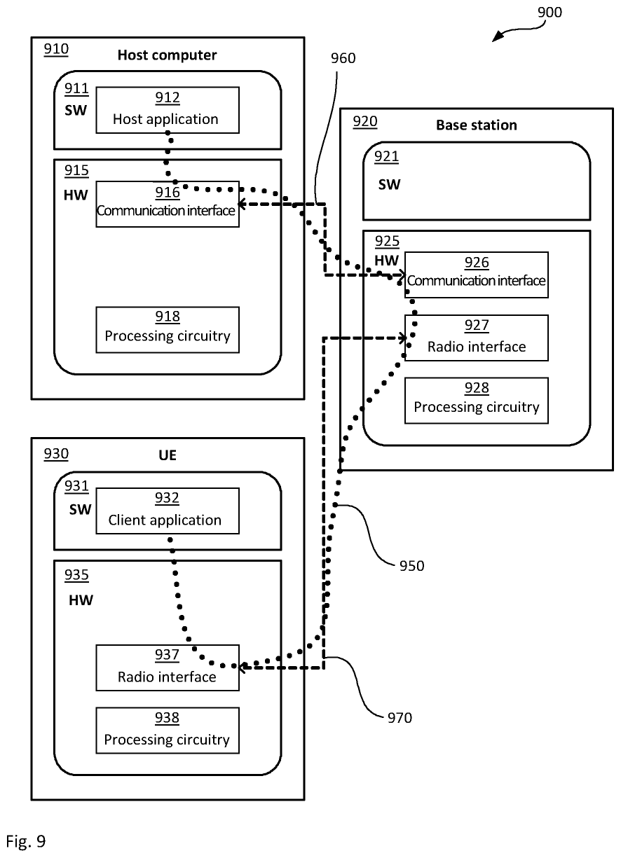

Example implementations, in accordance with an embodiment of the UE, base station and host computer discussed in the preceding paragraphs, will now be described with reference to FIG. 9. In a communication system 900, a host computer 910 comprises hardware 915 including a communication interface 916 configured to set up and maintain a wired or wireless connection with an interface of a different communication device of the communication system 900. The host computer 910 further comprises processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as a UE 930 connecting via an OTT connection 950 terminating at the UE 930 and the host computer 910. In providing the service to the remote user, the host application 912 may provide user data, which is transmitted using the OTT connection 950. The user data may depend on the location of the UE 930. The user data may comprise auxiliary information or precision advertisements (also: ads) delivered to the UE 930. The location may be reported by the UE 930 to the host computer, e.g., using the OTT connection 950, and/or by the base station 920, e.g., using a connection 960.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with a UE 930 located in a coverage area (not shown in FIG. 9) served by the base station 920. The communication interface 926 may be configured to facilitate a connection 960 to the host computer 910. The connection 960 may be direct, or it may pass through a core network (not shown in FIG. 9) of the telecommunication system and/or through one or more intermediate networks outside the telecommunication system. In the embodiment shown, the hardware 925 of the base station 920 further includes processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, base station 920 and UE 930 illustrated in FIG. 9 may be identical to the host computer 830, one of the base stations 812a, 812b, 812c and one of the UEs 891, 892 of FIG. 8, respectively. This is to say, the inner workings of these entities may be as shown in FIG. 9, and, independently, the surrounding network topology may be that of FIG. 8.

In FIG. 9, the OTT connection 950 has been drawn abstractly to illustrate the communication between the host computer 910 and the UE 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

The wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 950 between the host computer 910 and UE 930, in response to variations in the measurement results. The measurement procedure and/or the network functionality for reconfiguring the OTT connection 950 may be implemented in the software 911 of the host computer 910 or in the software 931 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which software 911, 931 may compute or estimate the monitored quantities. The reconfiguring of the OTT connection 950 may include message format, re-transmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer's 910 measurements of throughput, propagation times, latency and the like. The measurements may be implemented in that the software 911, 931 causes messages to be transmitted, in particular empty or “dummy” messages, using the OTT connection 950 while it monitors propagation times, errors etc.

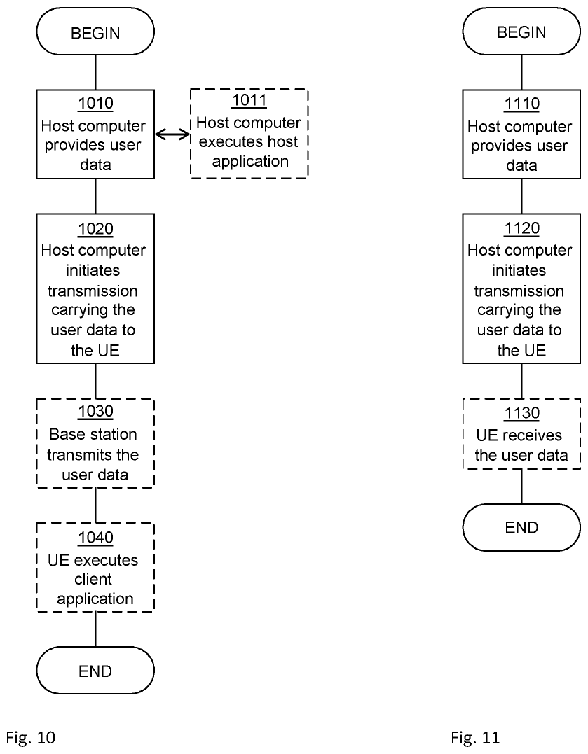

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this paragraph. In a first step 1010 of the method, the host computer provides user data. In an optional substep 1011 of the first step 1010, the host computer provides the user data by executing a host application. In a second step 1020, the host computer initiates a transmission carrying the user data to the UE. In an optional third step 1030, the base station transmits to the UE the user data which was carried in the transmission that the host computer initiated, in accordance with the teachings of the embodiments described throughout this disclosure. In an optional fourth step 1040, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this paragraph. In a first step 1110 of the method, the host computer provides user data. In an optional substep (not shown) the host computer provides the user data by executing a host application. In a second step 1120, the host computer initiates a transmission carrying the user data to the UE. The transmission may pass via the base station, in accordance with the teachings of the embodiments described throughout this disclosure. In an optional third step 1130, the UE receives the user data carried in the transmission.

As has become apparent from above description, at least some embodiments of the technique enable a transmitting radio device (e.g., a UE) to perform sensing 204 during a defined time which is sufficient to monitor the channel in order to avoid collisions for the next transmission 208. Same or further embodiments of the UE ensure that the UE is able to perform a resource selection operation 206 and/or transmission 208 of the data prior to the expiration of the packet delay budget, as an example of the transmission requirement. Same or further embodiments of the UE adjust at least one of the sensing window size and the resource selection window to the transmission requirement (e.g., one or more transmission parameters), such as PDB and/or priority, obtaining a more efficient resource allocation procedure.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method of performing a transmission on a sidelink (SL) from a transmitting radio device to one or more receiving radio devices, the method comprising:
obtaining data for transmission on the SL;
sensing a channel of the SL during a sensing window, wherein a duration of the sensing window depends on a transmission requirement associated with the data; and
based on a result of the sensing of the channel during the sensing window, selecting resources of the channel in a resource selection window for the transmission of the data.

2. The method of claim 1, wherein the transmission requirement comprises or is indicative of at least one of a packet delay budget (PDB) associated with the data and a priority associated with the data.

3. The method of claim 2, wherein the duration of the sensing window depends on at least one of the PDB and the priority.

4. The method of claim 2, wherein the resources of the channel are selected in the resource selection window prior to expiry of the PDB for the transmission of the data.

5. The method of claim 4, wherein the resource selection window starts prior to the end of the full sensing window depending on the transmission requirement.

6. The method of claim 2, wherein the duration of the sensing window depends on a time period remaining until the expiry of the PDB.

7. The method of claim 1, wherein the transmitting radio device determines the duration of the sensing window to be equal to or greater than a minimum duration that depends on the transmission requirement.

8. The method of claim 2, wherein the transmitting radio device determines the duration of the sensing window to be equal to or greater than a minimum duration that depends on the PDB, optionally wherein the minimum duration of the sensing window depends on a time period remaining until the expiry of the PDB.

9. The method of claim 2, wherein the transmitting radio device determines the duration of the sensing window to be equal to or less than a maximum duration that depends on the PDB.

10. The method of claim 1, wherein a duration of the resource selection window depends on the transmission requirement.

11. The method of claim 1, wherein a duration of the resource selection window depends on the PDB, optionally wherein the duration depends on a time period remaining until the expiry of the PDB.

12. The method of claim 11, wherein
the transmitting radio device determines the duration of the resource selection window to be equal to or greater than a minimum duration that depends on the PDB, and/or
the transmitting radio device determines the duration of the resource selection window to be equal to or less than a maximum duration that depends on the PDB.

13. The method of claim 2, wherein the sum of the duration of the sensing window and a duration of the resource selection window is equal to or less than a time period remaining until expiry of the PDB.

14. (canceled)

15. The method of claim 1, wherein the method is performed by the transmitting radio device.

16. The method of claim 1, further comprising or initiating:
receiving a control message at the transmitting radio device, the control message being indicative of the transmission requirement.

17. The method of claim 16, wherein the control message is received from a network node of a radio access network, RAN, serving the transmitting radio device, or
wherein the control message is received from one or more of the receiving radio devices.

18. The method of claim 1, wherein the duration of the sensing window is determined depending on the transmission requirement so that at least a minimum duration of the resource selection window required to perform the resource selection is achieved.

19. The method of claim 1, wherein the transmission requirement comprises or is indicative of a re-evaluation operation or a pre-emption operation.

20. The method of claim 1, wherein the transmission requirement comprises or is indicative of at least one of a priority of the data, a latency requirement of the data, a PDB of the data, a time remaining until expiry of the PDB, a duration of the resource selection window, a minimum of the duration of the resource selection window required by the transmitting radio device for performing the selecting step.

21. The method of claim 1, wherein the transmission requirement comprises or is indicative of parameters related to at least one of the data, the transmission of the data, and the channel of the SL.

22. (canceled)

23. A radio device for performing a transmission on a sidelink, SL, from the transmitting radio device to one or more receiving radio devices, the radio device comprising memory operable to store instructions and processing circuitry operable to execute the instructions, such that the radio device is operable to:
upon arrival of data for the transmission on the SL, sense a channel of the SL during a sensing window, wherein a duration of the sensing window depends on a transmission requirement associated with the data; and
based on a result of the sensing of the channel during the sensing window, select resources of the channel in a resource selection window for the transmission of the data.

24-26. (canceled)

27. A user equipment (UE) configured to communicate with a network node or with a radio device functioning as a gateway, the UE comprising a radio interface and processing circuitry configured to:
upon arrival of data for the transmission on the SL, sense a channel of the SL during a sensing window, wherein a duration of the sensing window depends on a transmission requirement associated with the data; and
based on a result of the sensing of the channel during the sensing window, select resources of the channel in a resource selection window for the transmission of the data.

28-33. (canceled)
